(19) United States
(12) Patent Application Publication
(10) Pub. No.: US 2017/0206515 A1
(43) Pub. Date: Jul. 20, 2017

(54) SETTLEMENT SYSTEM AND SETTLEMENT METHOD

(71) Applicant: NOMURA RESEARCH INSTITUTE, LTD., Tokyo (JP)

(72) Inventors: Shinichirou ARIKAWA, Tokyo (JP); Eiji FUJIYOSHI, Tokyo (JP)

(73) Assignee: NOMURA RESEARCH INSTITUTE, LTD., Tokyo (JP)

(21) Appl. No.: 15/477,173

(22) Filed: Apr. 3, 2017

Related U.S. Application Data
(63) Continuation of application No. PCT/JP2014/084193, filed on Dec. 24, 2014.

(51) Int. Cl. G06Q 20/16; G06Q 40/02; G06Q 20/38

(52) U.S. Cl. CPC G06Q 20/16; G06Q 20/381; G06Q 40/02

(57) ABSTRACT

A settlement system provides a means that is highly convenient by avoiding a foreign exchange spread as much as possible at a time of settlements between different currency types in offshore EC. According to a representative embodiment, provided is a settlement gateway that: detects a deposit using a first currency type from a consumer to a predetermined deposit/withdrawal bank account; issues a first virtual currency of the first currency type equivalent to an amount of money relating to the deposit; changes the first virtual currency into a second virtual currency of a second currency type; and instructs a withdrawal equivalent to an amount of money in the second virtual currency from the deposit/withdrawal bank account to a bank account of a merchant.

### TECHNICAL FIELD

The present invention relates to a settlement technique in electronic commerce (EC), and particularly to a technique effectively applied to a settlement system and a settlement method to support a settlement in so-called “offshore EC”.

### BACKGROUND ART

Along with popularization and development of IT environment such as the Internet, a so-called “offshore EC” market where a business operator who sells a product or service through electronic commerce provides the product or the like to an overseas consumer in order for expansion of sales channels and the like has expanded. In the offshore EC, transaction is performed between the consumer and a store (hereinafter, will be described as a “merchant” in some cases) beyond countries. Thus, a case where currency in which the merchant receives payment is different from currency used by the consumer for the payment may occur in the settlement. In general, a settlement due to a credit card, overseas remittance via a bank, or the like is used, and the settlement is performed by conversion of the currency due to a credit card company, the bank, or the like.

As a technique relating to the settlement in the offshore EC, for example, Japanese Patent Application Laid-open No. 2012-501013 (Patent Document 1) describes a technique of using an intermediary platform when a buyer purchases a product in an offshore merchant website using a local currency. Here, the buyer places an order at the offshore merchant website, and the website transmits an order request to the intermediary platform. The intermediary platform calculates a purchase amount in local currency, and exchanges the local currency amount provided by the user into an equivalent foreign currency amount through a financial platform, and sends the offshore merchant website a transaction message indicating successful payment to allow shipping of the product.

In addition, for example, Japanese Patent Application Laid-open No. 2012-256200 (Patent Document 2) describes a technique of avoiding an exchange rate fluctuation risk and reducing a commission for an international settlement. Here, a first exchange rate, which is applied to an exporter, and a second exchange rate, which is obtained by adding a broker's profit to the first exchange rate, are inputted. In addition, deposit data including an export destination currency price which expresses a price of an exported product in export destination currency and an export destination account is received; the export destination account included in the deposit data and the export destination currency price are stored to be associated with each other; the export destination currency price is changed from the export destination account into an export source account; a first export source currency price is obtained based on the export destination currency price and a first exchange rate; a second export source currency price is obtained based on the export destination currency price and a second exchange rate; a difference between the first export source currency price and the second export source currency price is obtained; the difference is stored in association with a broker account; and the first export source currency price is stored in association with a receiving account.

### PRIOR ART DOCUMENTS

### Patent Documents

Patent Document 1: Japanese Patent Application Laid-open No. 2012-501013

Patent Document 2: Japanese Patent Application Laid-open No. 2012-256200

### SUMMARY OF THE INVENTION

### Problems to be Solved by the Invention

When a settlement technique such as a credit card or bank remittance in the offshore EC is used and the settlement technique as described in Patent Document 1 is used, a unique exchange rate in which a spread is added is generally used by a credit card company, a bank or other intermediary business operators or the like at a time of converting a currency. As a result, the exchange rate becomes more expensive than an exchange rate in the market so that cost burden on a user becomes heavier, which results in abatement of convenience.

In addition, when the settlement technique as described in Patent Document 2 is used, there is no need of handling the settlement as the overseas remittance by creating the export source account and the export destination account inside the same bank, and there is such a constraint that the accounts need to be created inside the same bank, which also results in abatement of convenience and flexibility.

Therefore, an object of the present invention is to provide a settlement system and a settlement method capable of providing a means that is highly convenient by avoiding a foreign exchange spread as much as possible at the time of the settlements between different currency types in the offshore EC.

The above and other objects and novel characteristics of the present invention will be apparent from the description of the present specification and the accompanying drawings.

### Means for Solving the Problems

The following is a brief description of an outline of the typical invention disclosed in the present application.

A settlement system according to a typical embodiment of the present invention is a settlement system that performs a settlement according to electronic commerce between a consumer and a merchant that belong to different currency zones, and the settlement system includes a settlement gateway that: detects a deposit with a first currency type from the consumer to a predetermined deposit/withdrawal bank account; issues a first virtual currency with the first currency type, the first virtual currency being equivalent to an amount of money relating to the deposit; changes the first virtual currency into a second virtual currency of a second currency type; and instructs a withdrawal equivalent to an amount of money in the second virtual currency from the deposit/withdrawal bank account to a bank account of the merchant.

### Effects of the Invention

The effects obtained by typical embodiments of the invention disclosed in the present application will be briefly described below.

That is, according to a representative embodiment of the present invention, it is possible to provide the means that is highly convenient by avoiding the foreign exchange spread as much as possible at the time of the settlements between the different currency types in the offshore EC.

### BRIEF DESCRIPTIONS OF THE DRAWINGS

FIG. 1 is a diagram illustrating an overview regarding a configuration example of a settlement system that is an embodiment of the present invention;

FIG. 2 is a diagram illustrating an overview regarding an example of a settlement in offshore EC according to the embodiment of the present invention;

FIG. 3 is a diagram illustrating an overview regarding a concrete example of the settlement in the offshore EC according to the embodiment of the present invention;

FIG. 4 is a flowchart illustrating an overview regarding an example of a flow of a settlement process according to the embodiment of the present invention;

FIG. 5 is a sequence diagram illustrating an example of a flow of a process of determining a price in local currency according to the embodiment of the present invention;

FIG. 6 is a flowchart illustrating an example of a flow of a process of calculating an average acquisition rate according to the embodiment of the present invention;

FIG. 7 is a sequence diagram illustrating an example of each flow of a process of monitoring a deposit and a process of issuing a virtual currency according to the embodiment of the present invention;

FIG. 8 is a sequence diagram illustrating an example of each flow of a process of instructing a currency change order and a process of instructing redemption according to the embodiment of the present invention;

FIG. 9 is a sequence diagram illustrating an example of each flow of a process of requesting a withdrawal and a withdrawal process according to the embodiment of the present invention;

FIG. 10 is a diagram illustrating an overview regarding an example of a settlement in conventional offshore EC; and

FIG. 11 is a diagram illustrating an overview regarding a concrete example of the settlement in the conventional offshore EC.

### DETAILED DESCRIPTION OF PREFERRED EMBODIMENTS

Hereinafter, an embodiment of the present invention will be described in detail with reference to the drawings. Incidentally, the same part will be denoted by the same reference sign, in principle, in the respective drawings for description of the embodiment, and the repeated description thereof will be omitted. In addition, hereinafter, the description will be given in comparison with conventional techniques in order to facilitate understanding of characteristics of the present invention.

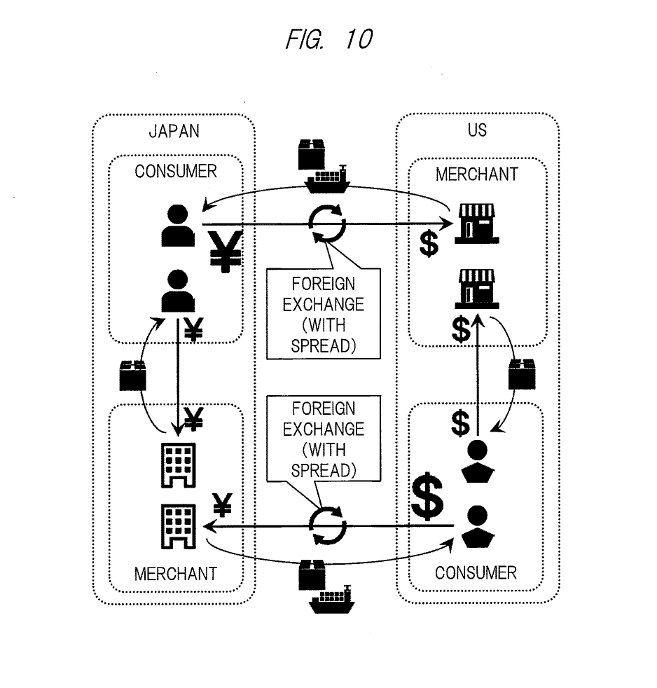

FIG. 10 is a diagram illustrating an overview regarding an example of a settlement in conventional offshore EC. Consumers and merchants of Japan are illustrated on a left side of the drawing, and merchants and consumers of the US are illustrated on a right side thereof. Each purchase transaction between the consumer and the merchant inside Japan and between the consumer and the merchant inside the US does not correspond to the offshore EC and, of course, its settlement is performed using a currency of each country. That is, the consumer of Japan pays money in Japanese yen (displayed as “¥” in the drawings), and the merchant of Japan receives the money in Japanese yen as it is. In addition, the consumer of the US pays money in US dollar (displayed as “$” in the drawings), and the merchant of the US receives the money in US dollar as it is.

On the other hand, in a case of the offshore EC where the consumer of Japan purchases a product or the like via a website of the merchant of the US, for example, when a settlement is performed using a credit card, the consumer of Japan pays money in Japanese yen, but the money is paid to the merchant of the US in US dollar. At this time, an amount of money that has been converted into US dollar based on a unique exchange rate used by a credit card company or the like is used as an amount of money to be paid by the consumer of Japan. In general, spread is added in the exchange rate by the credit card company or the like so that the exchange rate becomes more expensive than an exchange rate in a market. The same description may be applied even in a case where the consumer of the US purchases a product or the like from the merchant of Japan.

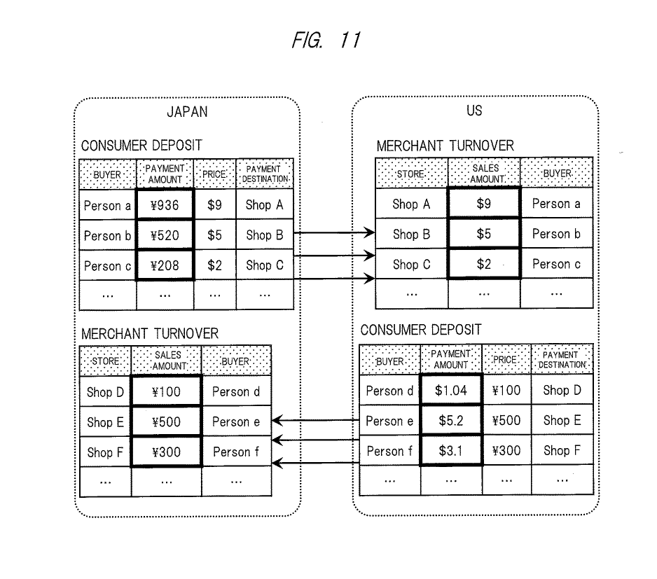

FIG. 11 is a diagram illustrating an overview regarding a concrete example of the settlement in the conventional offshore EC. Here illustrated is an example of a concrete settlement situation in the offshore EC between Japan and the US in the example of FIG. 10. For example, an upper side of the drawing illustrates a case where Japanese consumers “Person a”, “Person b” and “Person c” purchase products of $9, $5 and $2 sold by US merchants “Shop A”, “Shop B” and “Shop C”, respectively. If the exchange rate in the market is assumed to be 1$=¥100, each payment amount in Japanese yen originally becomes ¥900, ¥500 and ¥200. However, the exchange rate with the added spread of ¥4 (1$=¥104) is applied in the example of the drawing and, thus, each payment amount of the consumers of Japan become ¥936, ¥520 and ¥208, which are more expensive.

Similarly, a lower side of the drawing illustrates a case where the US consumers “Person d”, “Person e” and “Person f” purchase products of ¥100, ¥500 and ¥300 sold by Japanese merchants “Shop D”, “Shop E” and “Shop F”, respectively. In this case, each payment amount in US dollar originally becomes $1, $5 and $3. However, the exchange rate with the added spread of $0.04 (1.04$=¥100) is applied in the example of the drawing and, thus, each payment amount of the consumers of the US become $1.04, $5.2 and $3.1, which are more expensive.

In order to avoid such influence of the foreign exchange spread in the settlement in the offshore EC as much as possible, a gateway for settlement, which receives a deposit from the consumer and performs the deposit to the merchant between the consumer and the overseas merchant, is provided in a settlement system according to an embodiment of the present invention. Further, the settlement is not performed by performing the direct foreign exchange for each transaction. Instead, conversion into a virtual currency is temporarily performed inside the gateway, a change order between currency types using the virtual currency is managed as board information, and matching with a relative order is performed. Accordingly, it is possible to use the exchange rate in which spread is not added, the consumer may pay the amount of money determined based on the exchange rate, and cost burden at a time of purchasing the product can be reduced.

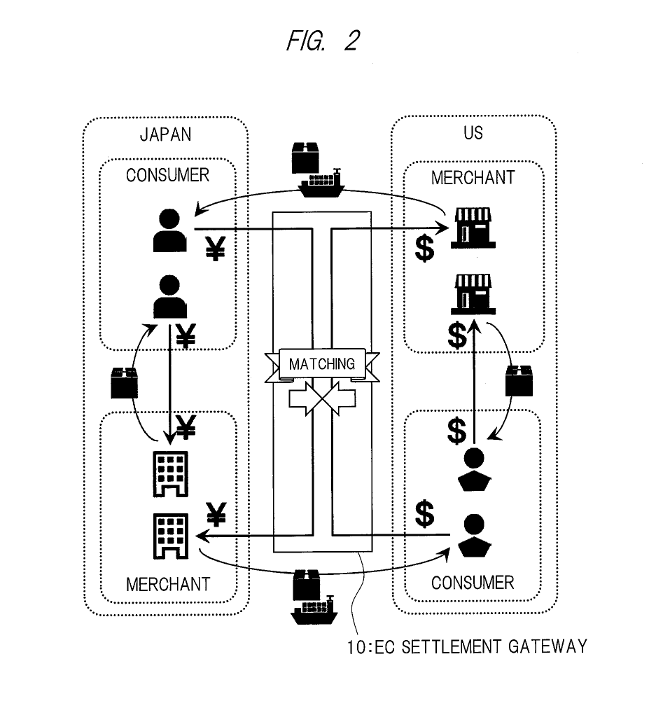

FIG. 2 a diagram illustrating an overview regarding an example of the settlement in the offshore EC according to the present embodiment. In the same case as the conventional example in FIG. 10, for example, the change (Japanese yen→US dollar) relating to the payment performed to the merchant of the US by the consumer of Japan, and the exchange (US dollar→Japanese yen) relating to the payment performed to the merchant of Japan by the consumer of the US are subjected to matching using the virtual currency in an intermediate EC settlement gateway 10 in the offshore EC in the present embodiment. Accordingly, the payment in Japanese yen performed by the consumer of Japan can be allocated to the merchant payment of Japan, the payment in US dollar performed by the consumer of the US can be allocated to the merchant payment of the US, and it is possible to exclude the influence of the foreign exchange spread without performing the actual currency change through the foreign exchange.

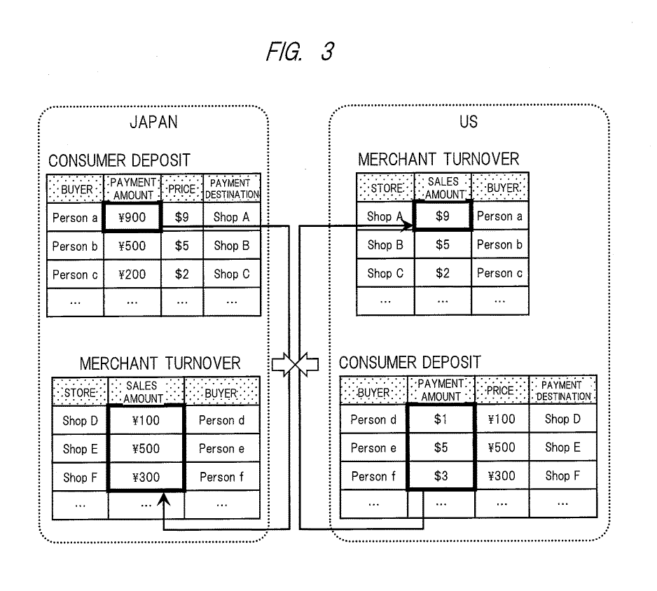

FIG. 3 is a diagram illustrating an overview regarding a concrete example of the settlement in the offshore EC according to the present embodiment. In the same case as the conventional example in FIG. 11, for example, the Japanese consumer “Person a” in an upper side of the diagram pays ¥900 in which the foreign exchange spread is not added in the case of purchasing the product of $9 from the US merchant “Shop A”. Incidentally, the foreign exchange spread is set to zero for the convenience of description, but a case where a small amount of spread is added may also actually occur depending on a result of the matching of the change. This payment of 1900 is set as a target of matching in the EC settlement gateway 10 since a total sales amount is ¥100+¥500+¥300=¥900 with respect to the US consumers “Person d” , “Person e” and “Person f” in the Japanese merchants “Shop D”, “Shop E” and “Shop F” in the a lower side of the drawing, and is allocated to the payment to these merchants.

Similarly, the US consumers “Person d” , “Person e” and “Person f” in the lower side of the drawing pay respectively $1, $5 and $3, each of which is not added with the foreign exchange spread in the case of purchasing the products of ¥100, ¥500 and ¥300 from the Japanese merchants “Shop D”, “Shop E” and “Shop F”. A total payment of $9 of the above-described payments is set as a target of matching in the EC settlement gateway 10 since a sales amount to the US consumer “Person a” in the US merchant “Shop A” is $9 in an upper side of the drawing and, thus, is allocated to the merchant payment.

In the present embodiment, the settlements accompanied by the change between the currency types are not only subjected to one-to-one matching as in the example of FIG. 3, but also can be subjected to m-to-n matching as long as the total sales amount and the total payment amount match each other. As a technique at a time of matching opposing changes, a so-called “Boarding method” or the like can be suitably used in a stock market or the like although not particularly limited.

<System Configuration>

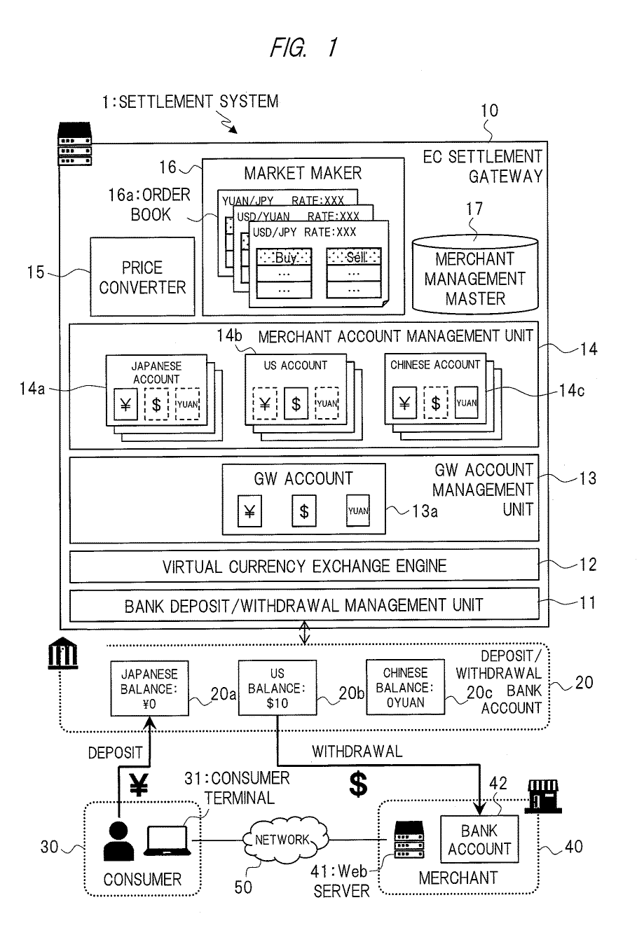

FIG. 1 is a diagram illustrating an overview regarding a configuration example of a settlement system that is an embodiment of the present invention. A settlement system 1 comprises offshore EC environment and the EC settlement gateway 10 that performs a settlement process relating to a transaction in the offshore EC. The offshore EC environment may be a general one, and includes: a consumer terminal 31 serving as an information processing terminal, which is connected via a network 50 such as the Internet or the like and used by a consumer 30; and a web server 41 that implements an EC website of a merchant 40 different from the consumer 30 in currency zone.

In addition, a deposit/withdrawal bank account 20 for each type of currencies, which is held for the settlement process of the EC settlement gateway 10, is provided as actual bank accounts used for the settlement, in addition to individual bank accounts 42 with which each of the merchants 40 receives the payment. In the example of FIG. 1, the bank accounts (deposit/withdrawal bank accounts 20a to 20c), which receive respectively deposits and withdrawals in Japanese yen, US dollar, and Chinese yuan, are provided as the deposit/withdrawal bank accounts 20. These accounts may be individually provided in banks or the like in countries within the respective currency zones.

The EC settlement gateway 10 is, for example, a server system that is implemented by server equipment and a virtual server or the like constructed on cloud computing environment, and includes each unit of a bank deposit/withdrawal management unit 11, a virtual currency exchange engine 12, a gateway (GW) account management unit 13, a merchant account management unit 14, a price converter 15, and a market maker 16, and the like which have been mounted as software that operates on such middleware as an OS (Operating System), a DBMS (DataBase Management System), and a web server program (not illustrated). In addition, such a data store as a merchant management master 17 implemented by a database and the like is provided.

The bank deposit/withdrawal management unit 11 has functions of monitoring a deposit with respect to each of the deposit/withdrawal bank accounts 20 and performing a withdrawal instruction such as transfer and remittance to the bank account 42 of each of the merchants 40. Concretely, the processing is performed by issuing a command or the like via such an interface as online banking and Internet banking of a bank which provides the deposit/withdrawal bank account 20.

The virtual currency exchange engine 12 has a function as a processing engine for implementing a virtual encrypted currency that can be distributed and exchanged on the network. The virtual currency exchange engine 12 may be one that has been implemented as an interface function with respect to an external virtual currency exchange engine or virtual currency exchange service. It is possible to suitably use a known technique as the virtual currency exchange engine 12. In the present embodiment, the description will be sometimes given by assuming the currency exchange network for enterprise as network using Ripple (registered trademark) (https://ripple.com/) in which a function group necessary for currency exchange is provided as OSS (Open Source Software) and is freely usable.

The GW account management unit 13 has a function of managing a GW account 13a which is an account of a virtual currency (corresponding to an “IOU” in Ripple) for the EC settlement gateway 10 provided on the virtual currency exchange engine 12 such as Ripple. The GW account management unit 13 issues a virtual currency of a predetermined currency type (Japanese yen (¥), US dollar ($) and Chinese yuan (yuan) in the example of FIG. 1) with respect to the GW account 13a. In addition, when a deposit (corresponding to redemption of IOU in Ripple) of the virtual currency to the GW account 13a from a merchant account to be described later is detected, the withdrawal instruction from the deposit/withdrawal bank account 20 to the bank account 42 of the targeted merchant 40 is outputted with respect to the bank deposit/withdrawal management unit 11.

The merchant account management unit 14 has a function of managing the merchant account which is an account of the virtual currency associated with each of the merchants 40. In the example of FIG. 1, one or more Japan accounts 14a, US accounts 14b, and China accounts 14c are respectively provided as the merchant accounts corresponding to the respective merchants 40 of Japan, the US, and China.

A currency type of the virtual currency that permits reception is set to each of the merchants. In general, only the currency type that is distributed in a targeted country is permitted, but another currency type may be permitted, for example, in a case where the merchant 40 of Japan permits reception in Chinese yuan. Incidentally, such setting information is registered in the merchant management master 17 and the like in advance. When there is a deposit of a virtual currency using a currency type other than the reception-permitted currency type, a change order to the reception-permitted currency type is placed with respect to the market maker 16 as described later, and performs the deposit process of the virtual currency that has been changed.

The price converter 15 has a function of: converting, into a price in local currency of the consumer, a price of a product or the like that is sold in an EC website provided by the web server 41 of the merchant 40 based on information of order books 16a held in the market maker 16 as described later; and presenting the converted price.

The market maker 16 has a function of: managing the information of the order book 16a held for each combination of changes between the currency types; and performing a change process. The order book 16a holds, as order board information, the information on the change order issued from the merchant account management unit 14. The market maker 16 establishes the change order by performing the matching as illustrated in above FIG. 3 with respect to the change order for sell/buy in the order book 16a. Incidentally, a concrete matching technique is not particularly limited, and a matching function provided in the virtual currency exchange engine 12 such as Ripple may be used, or a matching process may be uniquely constructed. In addition, the market maker 16 calculates an average acquisition rate in the change based on current board information depending on an instruction from the price converter 15 or the like, and outputs the calculated rate.

The merchant management master 17 is a table that holds master information regarding the merchant 40 who performs a settlement using the settlement system 1 according to the present embodiment. The merchant management master 17 manages information on the currency type in which the merchant 40 permits the deposit described above, the information on bank account 42, and the like.

Although the EC settlement gateway 10 is configured as a single server system in the example of FIG. 1, the configuration can be appropriately changed flexibly. For example, the EC settlement gateway 10 can be configured so that a gateway system for each country may be configured by dispersing and arranging the bank deposit/withdrawal management unit 11, the GW account management unit 13, the merchant account management unit 14 and the like in the respective countries, and that the price converter 15 and the market maker 16 are provided at one location in an aggregated manner.

In addition, the GW account management unit 13, the merchant account management unit 14, and the like are configured as the software having the function of managing the information on the account in the present embodiment, but can be implemented also as an “account object” which is obtained by integrating the information on the account and a function of accessing its information. Similarly, the market maker 16 can be also implemented as an “order book object” which is obtained by integrating the information of the order book 16a and a function of accessing its information.

<(Overall) Process Flow>

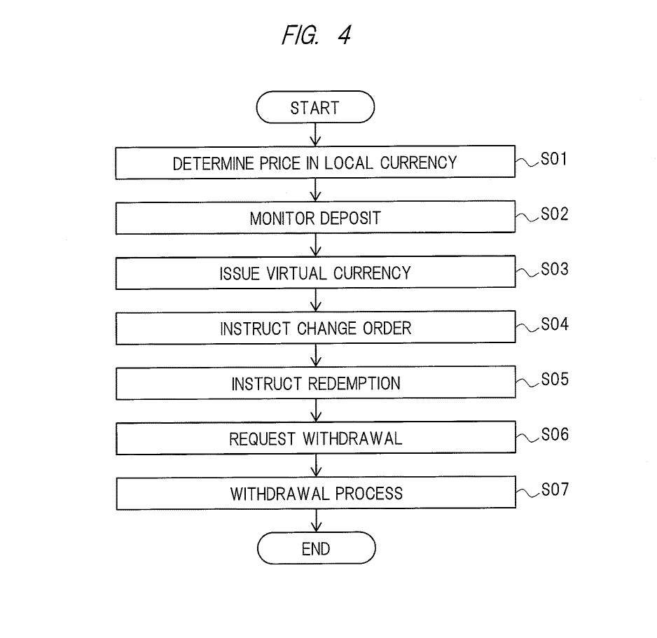

FIG. 4 is a flowchart illustrating an overview regarding an example of a flow of a settlement process according to the present embodiment. In the settlement process when the consumer 30 purchases the product or the like from the overseas merchant 40 using the offshore EC, first, the EC website of the merchant 40 accesses, prior to the settlement, the price converter 15 of the EC settlement gateway 10 to acquire a payment price of the consumer 30 in local currency with respect to a sales price of the product or the like, and presents the acquired payment price to the consumer 30 (S01). At this time, the price converter 15: refers to a board situation of the order book 16a in the market maker 16; converts the sales amount in the unit of a currency of a country, to which the merchant 40 belongs, into the payment amount in the unit of the currency of the country to which the consumer 30 belongs; and outputs the converted amount.

After the payment amount is determined and a purchase contract of the product or the like is concluded, the bank deposit/withdrawal management unit 11 of the EC settlement gateway 10 monitors whether the above-described payment amount has been deposited from the consumer 30 to the deposit/withdrawal bank accounts 20 (S02). The EC settlement gateway 10 designates the deposit/withdrawal bank account 20 as a destination of the deposit of the consumer 30 depending on the currency type. For example, in the case of the payment in Japanese yen in the example of FIG. 1, the deposit/withdrawal bank account 20a that receives deposits and withdrawals in Japanese yen is designated. The bank deposit/withdrawal management unit 11 regularly confirms presence or absence of the deposit to each of the deposit/withdrawal bank accounts 20. When there is a new deposit, the GW account management unit 13 is notified of its currency type, its amount of money, and its information on the merchant 40 as a payment destination.

Incidentally, for example, it is possible to grasp the information on the merchant 40 as the payment destination by inputting such information as an ID for specifying the merchant 40, an order number of a targeted transaction, and the like, into transfer information inputted when the consumer 30 deposits into the deposit/withdrawal bank account 20 via a transfer or the like. For example, when the information such as the ID that specifies the merchant 40 is designated, it is possible to specify the merchant 40 with reference to the merchant management master 17 in the EC settlement gateway 10. In addition, for example, when the purchase contract has been concluded in the merchant 40 in a case where the order number is designated, it is possible to specify the merchant 40 by causing the web server 41 to transmit the order number and the information on the merchant 40 to the EC settlement gateway 10 in advance via the network 50 or the like.

When the deposit from the consumer 30 has been grasped, the GW account management unit 13 that has received the notification thereof issues the virtual currency (IOU in Ripple) corresponding to (that is, equivalent to) the currency type and the deposit amount relating to the corresponding deposit, and remits the issued virtual currency to the merchant account associated with the targeted merchant 40 (S03).

The merchant account management unit 14 monitors a deposit to each merchant account. When the deposit of the virtual currency into the targeted merchant account is detected, if its currency type does not match the currency type that the merchant 40 permits receiving, the merchant account management unit 14 issues, to the market maker 16, a change order to exchange the currency type of the deposited virtual currency into the currency type that the merchant 40 permits receiving (S04). For example, an exchange order of “sell: ¥1,000/buy: $10” is issued to change ¥1,000 into $10. Incidentally, the information on each currency type that each of the merchants 40 permits receiving has been registered in advance in the merchant management master 17 and the like as described above.

On the other hand, when the currency type of the virtual currency which has been deposited into the merchant account matches the currency type that the merchant 40 permits receiving or when the virtual currency of a reception-permitted currency type according to a promise of the change order has been deposited into the merchant account, the merchant account management unit 14 remits the entire amount of the virtual currency deposited to the targeted merchant account to the GW account 13a (redemption of IOU in Ripple) (S05).

The GW account management unit 13 monitors the deposit of the virtual currency into the GW account 13a. When the deposit of the virtual currency from the merchant account is detected, the GW account management unit 13 transmits, to the bank deposit/withdrawal management unit 11, its currency type, the amount of money in actual currency corresponding to (that is, equivalent to) the deposit amount, and the information on the bank account 42 of the merchant 40 corresponding to the deposit-source merchant account, and requests a withdrawal (S06). The information on the bank account 42 of the targeted merchant 40 is registered in the merchant management master 17 and the like, in advance, as described above.

The bank deposit/withdrawal management unit 11 performs an actual withdrawal process, such as a transfer and a remittance, with respect to the bank account 42 of the targeted merchant 40 from the deposit/withdrawal bank account 20 (the deposit/withdrawal bank account 20b which receives deposits and withdrawals in US dollar in the example of FIG. 1) that handles the targeted currency type based on the information on the currency type, the amount of money, and the bank account 42, the information being received from the GW account management unit 13 (S07). The settlement in the offshore EC is completed through a series of processes described above.

<Process Flow (Price Determination in Local Currency)>

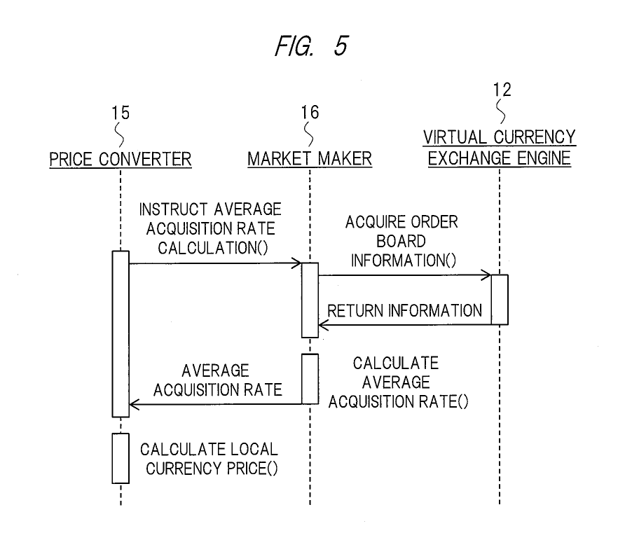

FIG. 5 is a sequence diagram illustrating an example of a flow of the process of determining the price in local currency in Step S01 of FIG. 4. The price converter 15 of the EC settlement gateway 10, which has received a request for acquisition of the payment price in local currency, first instructs the market maker 16 to calculate an average acquisition rate based on the order board information. The market maker 16, which has received the instruction, first issues a command or the like to the virtual currency exchange engine 12, and acquires the order board information on the change order between targeted currency types, that is, the information on the order books 16a. Further, the average acquisition rate is calculated using a below-described technique or the like, based on the information on the order books 16a, to respond to the price converter 15. In the price converter 15, the payment amount of the consumer 30 in local currency is calculated based on the average acquisition rate and the sales amount of the product or the like.

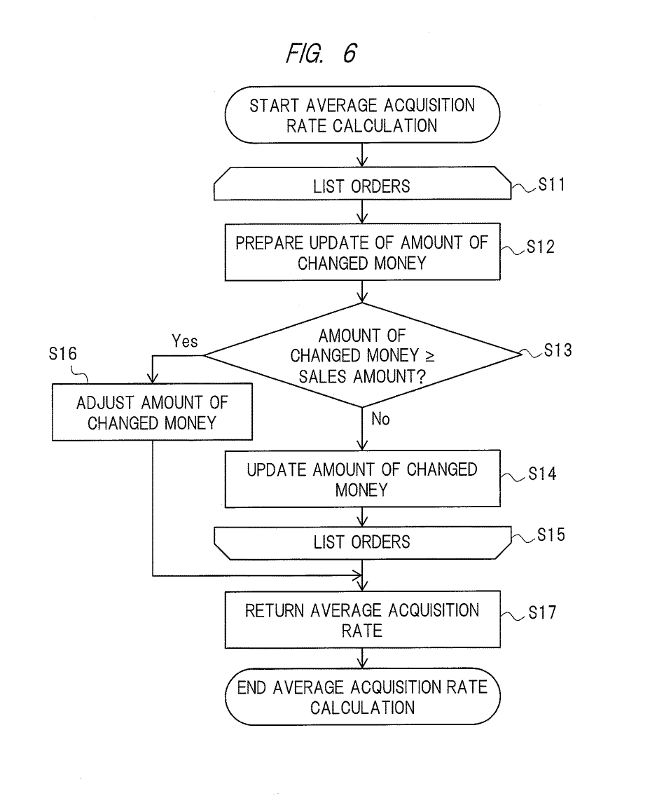

FIG. 6 is a flowchart illustrating an example of a flow of the process of calculating the average acquisition rate in the example of FIG. 5. First, a loop process to repeat a process about a list of the change orders is started (S11). In the loop process, first, a price (hereinafter, will be described as “a”) which has been exchanged according to the targeted change order is calculated as a preparation process for updating an amount of changed money based on the targeted change order and, by adding “α” to a total amount of money changed so far (hereinafter, will be described as “A”), the amount of changed money “A+α” is calculated. Incidentally, the information on the change order includes information on an exchange rate and an exchange-targeted amount, for example, “exchange ¥5,000 with a rate of 1$=¥100”.

Next, whether the amount of changed money “A+α” is equal to or more than the sales amount in a currency of a selling country is determined (S13). When “A+α” does not meet the sales amount, the amount of money that has been changed so far is updated (S14). That is, the process flow moves to a process of a next change order using “A+α” as a new “A” (S15, S11).

On the other hand, when “A+α” is equal to or more than the sales amount in Step S13, the average acquisition rate is adjusted so that the amount of changed money “A+α” becomes equal to the sales amount (S16). For example, when the amount of “A” before being addition of “α” does not meet the sales amount, the average acquisition rate is calculated using the following formula.

Average Acquisition Rate=Average Acquisition Rate+Exchange Rate of Targeted Change Order×(Sales Amount−A)/A

Thereafter, the loop process is ended, the average acquisition rate calculated in Step S16 is returned (S17), and the process is ended. Through a series of processes described above, it is possible to acquire an average exchange rate in the virtual currency between the targeted currency types based on the board information on the change orders in the order books 16a.

<Process Flow (Deposit Monitoring, Virtual Currency Issuance)>

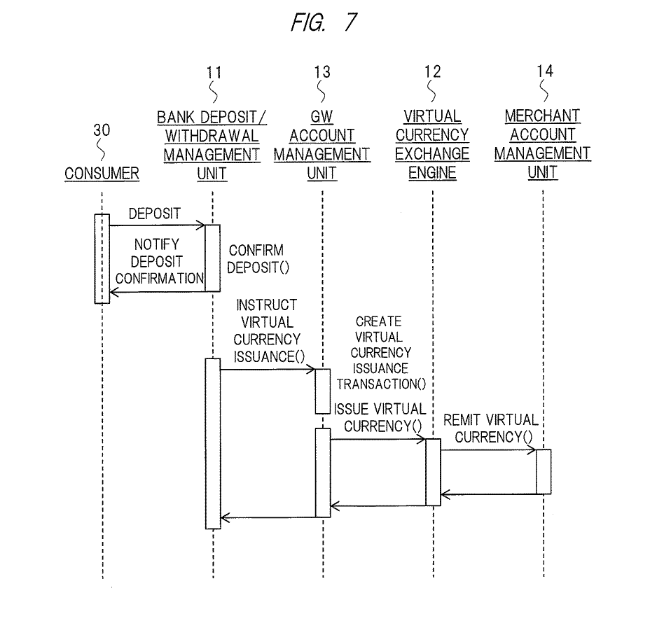

FIG. 7 is a sequence diagram illustrating an example of each flow of the process of monitoring the deposit in Step S02 and the process of issuing the virtual currency in Step S03 of FIG. 4. First, the consumer 30 performs an actual deposit to the deposit/withdrawal bank account 20 designated by the EC settlement gateway 10. The bank deposit/withdrawal management unit 11 detects the deposit by regularly confirming presence or absence of the deposit to the account, and notifies the consumer 30 of the deposit confirmation if necessary. For example, it is possible to notify the deposit confirmation by sending an electronic mail to the consumer 30.

The bank deposit/withdrawal management unit 11, which has detected the deposit, instructs issuance of the virtual currency (IOU in Ripple) corresponding to (that is, equivalent to) the deposited currency type and the amount of money with respect to the GW account management unit 13. The GW account management unit 13, which has received the issuance instruction, creates a transaction including a command(s) or the like for the virtual currency issuance and the remittance, and executes the transaction with respect to the virtual currency exchange engine 12. Accordingly, the virtual currency is issued by the virtual currency exchange engine 12, and the issued virtual currency is remitted to the merchant account associated with the targeted merchant 40.

<Process Flow (Change Order Instruction, Redemption Instruction)>

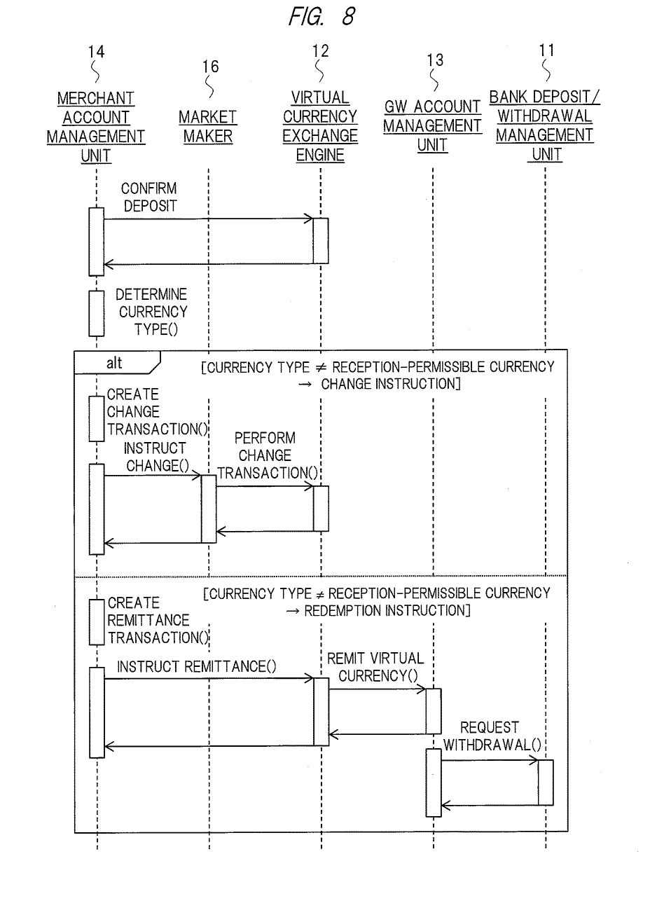

FIG. 8 is a sequence diagram illustrating an example of each flow of the process of instructing the change order in Step S04 and the process of instructing the redemption in Step S05 of FIG. 4. First, the merchant account management unit 14 regularly confirms the virtual currency exchange engine 12 regarding whether there is a deposit transaction in the virtual currency with respect to each of the merchant accounts associated with the merchants 40. Next, determination of the currency type is performed when the deposit is detected by a response from the virtual currency exchange engine 12. Concretely, information on the currency type relating to the deposit is acquired through contents of the response from the virtual currency exchange engine 12. In addition, information on the currency type that the targeted merchant account (or the merchant associated therewith) permits receiving is acquired with reference to the merchant management master 17. Further, it is determined whether these currency types match each other.

When the currency types do not match each other, a process of instructing a change for the exchange into the reception-permitted currency type is performed. Concretely, the merchant account management unit 14 first creates a transaction including a command or the like for changing the virtual currency, and sends a change instruction including this transaction message to the market maker 16. The market maker 16 transmits the received transaction message to the virtual currency exchange engine 12 so that the virtual currency exchange engine 12 executes the transaction for the change instruction and performs the change in the virtual currency between the currency types.

On the other hand, when the deposited currency type matches the currency type that the target merchant 40 permits receiving, the process of instructing the redemption for remitting the deposited virtual currency to the GW account 13a is performed. Concretely, the merchant account management unit 14 first creates a transaction including a command or the like for remitting the virtual currency to the GW account 13a, and executes the created transaction with respect to the virtual currency exchange engine 12. Accordingly, the virtual currency inside the targeted merchant account is remitted to the GW account 13a by the virtual currency exchange engine 12. Thereafter, the GW account management unit 13 requests a withdrawal to the bank account 42 of the targeted merchant 40 with respect to the bank deposit/withdrawal management unit 11, and details of this process will be described later.

<Process Flow (Withdrawal Request, Withdrawal Process)>

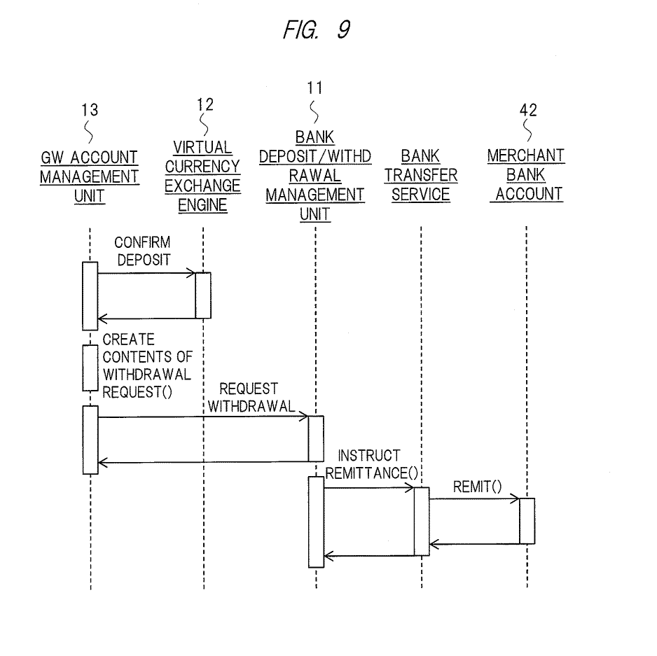

FIG. 9 is a sequence diagram illustrating an example of each flow of the process of requesting the withdrawal in Step S06 and the withdrawal process in Step S07 of FIG. 4. First, the GW account management unit 13 regularly confirms the virtual currency exchange engine 12 regarding whether there is the deposited transaction in the virtual currency with respect to the GW account 13a. Next, contents of the withdrawal request are created when the deposit is detected by the response from the virtual currency exchange engine 12. Concretely, the information on the currency type and the amount of money relating to the deposit, and the information on the deposit-source merchant account are acquired through the contents of the response from the virtual currency exchange engine 12. Further, the information on the merchant 40 and the bank account 42 associated with the merchant account is acquired with reference to the merchant management master 17, and the information on the amount of money in the actual currency corresponding to (that is, equivalent to) the currency type and the deposited amount in the virtual currency and the information on the bank account 42 are created as the contents of the withdrawal request.

Thereafter, the contents of the withdrawal request are transmitted to the bank deposit/withdrawal management unit 11 to perform the withdrawal request. The bank deposit/withdrawal management unit 11 instructs transfer service or remittance service provided by the bank or the like about the actual remittance from the deposit/withdrawal bank account 20, which handles the targeted currency type, to the targeted bank account 42 based on the contents of the received withdrawal request. The transfer service or the like provided by the bank or the like performs the actual remittance from the deposit/withdrawal bank account 20 to the bank account 42 of the targeted merchant 40 according to the instructed contents. It is possible to perform the settlement process in the offshore EC through a series of processes described above.

As described above, the settlement system 1 that is the embodiment of the present invention provides the EC settlement gateway 10 between the consumer 30 and the overseas merchant 40, and does not perform the settlement by directly conducting the foreign exchange for each transaction, but causes the gateway to temporarily convert the deposit into the virtual currency inside the EC settlement gateway 10, manage the change order between the currency types using the virtual currency as the board information in the order books 16a, and match the opposing orders. Accordingly, it is possible to use the exchange rate of the market in the virtual currency exchange network, the consumer may pay the amount of money determined based on the exchange rate, and it is possible to avoid the influence of the spread and reduce the cost burden at the time of purchasing the product.

In the foregoing, the invention made by the inventors of the present invention has been concretely described based on the embodiments. However, it is needless to say that the present invention is not limited to the foregoing embodiments and various modifications and alterations can be made within the scope of the present invention. For examples, the embodiments above have been described in detail so as to make the present invention easily understood, and the present invention is not always limited to the embodiment having all of the described constituent elements. Furthermore, another configuration may be added to a part of the configuration of each embodiment, and a part of the configuration of each embodiment may be eliminated or replaced with another configuration.

### INDUSTRIAL APPLICABILITY

The present invention can be used in the settlement system and the settlement method that supports the settlement in the offshore EC.

### REFERENCE NUMERALS LIST

1 . . . settlement system;

10 . . . EC settlement gateway; 11 . . . bank deposit/withdrawal management unit; 12 . . . virtual currency exchange engine; 13 . . . GW account management unit; 13a . . . GW account; 14 . . . merchant account management unit; 14a . . . Japanese account; 14b . . . US account; 14c . . . Chinese account; 15 . . . price converter; 16 . . . market maker; 16a . . . order book; 17 . . . merchant management master;

20, 20a to 20c . . . deposit/withdrawal bank account;

30 . . . consumer;

31 . . . consumer terminal;

40 . . . merchant; 41 . . . web server; 42 . . . bank account; and

50 . . . network.

1. A settlement system that performs a settlement according to electronic commerce between a consumer and a merchant that belong to different currency zones, the settlement system comprising:
a settlement gateway that: detects a deposit with a first currency type from the consumer to a predetermined deposit/withdrawal bank account; issues a first virtual currency with the first currency type, the first virtual currency being equivalent to an amount of money relating to the deposit; changes the first virtual currency into a second virtual currency of a second currency type; and instructs a withdrawal equivalent to an amount of money in the second virtual currency from the deposit/withdrawal bank account to a bank account of the merchant.

2. The settlement system according to claim 1,
wherein the settlement gateway comprises:
a gateway account management unit that: remits the issued first virtual currency to a merchant account which is a virtual currency account associated with the merchant; and instructs the withdrawal equivalent to the amount of money in the second virtual currency when the second virtual currency is remitted from the merchant account to a gateway account which is a virtual currency account associated with the settlement gateway; and
a merchant account management unit that: changes the first virtual currency into the second currency type to acquire the second virtual currency when the first virtual currency is remitted to the merchant account and when the first currency type does not match the second currency type registered in advance as a currency type that the merchant permits receiving; and remits the acquired second virtual currency to the gateway account.

3. The settlement system according to claim 2,
wherein the settlement gateway further comprises a market maker that performs a change by matching a sell order and a buy order in a virtual currency between the first currency type and the second currency type.

4. The settlement system according to claim 3,
wherein the settlement gateway further comprises a price converter that calculates an average acquisition rate at a time of changing the first currency type into the second currency type based on board information on the sell order and the buy order held by the market maker.

5. A settlement method in a settlement system that performs a settlement according to electronic commerce between a consumer and a merchant that belong to different currency zones, the settlement method comprising:
a first step of causing the settlement system to detect a deposit using a first currency type from the consumer to a predetermined deposit/withdrawal bank account;
a second step of causing the settlement system to issue a first virtual currency with the first currency type, the first virtual currency being equivalent to an amount of money relating to the deposit;
a third step of causing the settlement system to change the first virtual currency into a second virtual currency with a second currency type; and
a fourth step of causing the settlement system to instruct a withdrawal equivalent to an amount of money in the second virtual currency from the deposit/withdrawal bank account to a bank account of the merchant.

6. The settlement method according to claim 5,
wherein the settlement system in the second step issues the first virtual currency, and then remits the issued first virtual currency to a merchant account which is a virtual currency account associated with the merchant,
the settlement system in the third step: changes the first virtual currency into the second currency type to acquire the second virtual currency when the first virtual currency is remitted to the merchant account and when the first currency type does not match the second currency type registered in advance as a currency type that the merchant permits receiving; and remits the acquired second virtual currency to a virtual currency settlement account associated with the settlement system, and
the fourth step instructs the withdrawal equivalent to an amount of money in the second virtual currency when the second virtual currency is remitted from the merchant account to the settlement account.

7. The settlement method according to claim 6, further comprising:
a fifth step of causing the settlement system to perform a change by matching a sell order and a buy order in a virtual currency between the first currency type and the second currency type.

8. The settlement method according to claim 7, further comprising:
a sixth step of causing the settlement system to calculate an average acquisition rate at a time of changing the first currency type into the second currency type based on board information on the held sell order and buy order.
